(19) United States
(12) Patent Application Publication
(10) Pub. No.: US 2008/0198293 A1
(43) Pub. Date: Aug. 21, 2008

(54) Illumination Device For a Display, and Method of Manufacturing the Same

(75) Inventors: Erik Boonekamp, Eindhoven (NL); Barry Mos, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,031

(22) PCT Filed: May 12, 2006
(86) PCT No.: PCT/IB2006/051490

§ 371 Date: Nov. 20, 2007

(30) Foreign Application Priority Data
May 27, 2005 (EP) 05104557.3

(51) Int. Cl. G02F 1/1335; G02B 6/00; B29D 7/01

(52) U.S. Cl. 349/62; 385/11; 264/1.34

(57) ABSTRACT

An illumination device (1) for illuminating a display (2) with polarized light, the illumination device including a waveguide (3) for guiding light and an anisotropic layer (10) comprising a first surface (5) arranged to face towards the waveguide and a second surface (7) arranged to lace away from the waveguide, wherein the first surface is provided with an outcoupling means (6) for outcoupling light having a predetermined polarization from the waveguide and the second surface is provided with a collimating means (8) for collimating the light outcoupled from the waveguide in a predetermined direction.

### TECHNICAL FIELD

The invention relates to an illumination device for illuminating a display with polarized light and a method of manufacturing such an illumination device.

### BACKGROUND TO THE INVENTION AND PRIOR ART

Flat panel displays, such as liquid crystal displays (LCD), are components of many kinds of electronic equipment, including portable devices, such as computers, personal digital assistants (PDA), digital recording devices, hard drive devices and mobile communication terminals etc. One consideration of such devices is to use energy in an efficient manner, so that when such devices are run on batteries, their power consumption is minimized in order to prolong battery life.

A polarized illumination device, such as a back light or a front light, has found wide spread application in the electronics industry because it can recycle light from one polarization which is not needed, for example, the P-polarization, and turn it into the desired polarization state, the S-polarization. Such recycling of light cannot be achieved with conventional unpolarized illumination devices, which require that a separate polarizing device be attached to the LCD. Thus polarized illumination devices theoretically increase the light efficiency by a factor of two. Further the structure of the polarized backlight makes the overall structure of the stack of components that make up the backlight thinner and cheaper to manufacture. Such a backlight is known, for example, from US 2003/0058386. In this document, it is further proposed to collimate the light incident into the system. Whilst it has been found that this increases the contrast ratios of the output light, it suffers the drawback that the light output is lower.

US 2003/0058383 describes a backlight comprising a waveguide and an anisotropic layer provided with microstructures. At one end of the waveguide a light source is provided. At the other end of the waveguide a depolarizing end reflector is provided. The anisotropic layer is adhered with an index matching isotropic glue to the side of the waveguide oriented towards the LCD panel. The structures on the boundary between the isotropic adhesive layer and the anisotropic layer only deflect S-polarized light, which then exits the light guide towards the LCD panel, whilst the P polarized light remains inside the waveguide, where it may be transformed into S-polarized light on its journey, for example by reflection by the depolarizing end reflector. A problem with such conventional backlights is that the light distribution of light output from the devices is rather wide. This is particularly disadvantageous for portable and handheld displays where the viewer demands maximum light output in a particular direction. Whilst foils have been developed to enhance brightness. The incorporation of such foils into backlighting devices adds to the complexity and expense of the device, since it requires the inclusion of the foil in a whole stack of foils which include diffusers, polarizers and the like.

It is an object of the present invention to address those problems encountered in conventional backlight devices. In particular, it is an object of the present invention to improve contrast ratios whilst maintaining light output levels. It is a further object of the invention to improve the light distribution in a particular viewing direction whilst avoiding the problem of increasing the complexity of the manufacture of the device.

### SUMMARY OF THE INVENTION

According to a first aspect of the invention, there is provided an illumination device for illuminating a display with polarized light, the illumination device including a waveguide for guiding light and an anisotropic layer comprising a first surface arranged to face towards the waveguide and a second surface arranged to face away from the waveguide, wherein the first surface is provided with an outcoupling means for outcoupling light having a predetermined polarization from the waveguide and the second surface is provided with a collimating means for collimating the light outcoupled from the waveguide in a predetermined direction.

In this way, light provided by a light in the illumination device is more efficiently used. The brightness experienced by a viewer when using the device is improved without requiring additional power to be supplied to the device. This is because the anisotropic layer provides two functions, rather than one. The layer is able to couple out only the S-polarized light as well as collimate the outcoupled light. The collimated outcoupled light has an improved light outcoupling distribution, so that the viewer receives improved light output from the display in a viewing position. Further, this improved functionality of the anisotropic layer is achieved without requiring additional foil components or adding to the complexity of the manufacture of the device. Thus, conventional dedicated foils for collimating light can be dispensed with, rendering the manufacture of the illumination device simpler and cheaper. A further advantage of the present invention is that an illumination device incorporating the anisotropic layer is thinner than conventional devices, which improves is versatility and range of applications, and further allows the size of the devices in which the illumination device is disposed to be reduced.

In a preferred embodiment, the outcoupling means comprises a first plurality of microstructures formed in the first surface wherein at least one of the first plurality of microstructures has a first longitudinal axis, and wherein the collimating means comprises a second plurality of microstructures formed in the second surface.

In a preferred embodiment, the second plurality of microstructures is arranged to collimate the light in the direction of the first longitudinal axis.

In a preferred embodiment, at least one of the second plurality of microstructures has a second longitudinal axis which is disposed at an angle with respect to the first longitudinal axis. Whilst the form of the second plurality of microstructures determines one direction of collimation, the orientation of the first longitudinal axis with respect to the second longitudinal axis determines the direction of collimation of the light collimated by the second plurality of microstructures. In this way, the direction in which the outcoupled light is distributed is controlled such that the outcoupled light has an improved distribution in a chosen direction.

In a preferred embodiment, the angle between the first and second longitudinal axes is in a range defined from 90 degrees minus a total internal reflection angle of the waveguide to 90 degrees plus the total internal reflection angle. In this way, further improved collimation in a desired direction is achieved.

In a preferred embodiment, the first longitudinal axis is substantially perpendicular to the second longitudinal axis. In this way, the light is collimated in a perpendicular to the display.

In a preferred embodiment, the second plurality of microstructures comprises a plurality of optical elements extending out of the second surface, the optical elements being disposed at an angle with respect to a plane in which the waveguide is disposed. In this way, a greater proportion of the light outcoupled from the device is collimated. Thus, resulting in a further improved distribution of outcoupled light.

In a preferred embodiment, the optical elements make an angle in the range of about plus or minus 45 degrees with a direction of propagation of the outcoupled light. In this way, depending on the indices of refraction of the anisotropic layer, a yet further optimized collimating effect is achieved.

In a preferred embodiment, the optical elements are prisms. In this way the surface area of the second surface is increased by the provision of optical elements which are relatively easy to reproduce on the surface of the layer and which collimate the outcoupled light in a predetermined direction.

In a preferred embodiment, the prisms are tilted with respect to one another. In this way, the degree of collimation may be further controlled to provide a desired degree of collimation.

In a preferred embodiment, the prisms are of different sizes. In this way, Moiré effects are reduced.

In a preferred embodiment, the optical elements have a wavelike structure.

According to a second aspect of the invention, there is provided a liquid crystal display device, comprising a liquid crystal display panel and an illumination device as described in the above, for providing polarized light to said liquid crystal display panel.

According to a third aspect of the invention, there is provided a method of manufacturing an anisotropic layer for use in an illumination device for illuminating a display with polarized light, the illumination device including a waveguide for guiding light, the method including embossing the layer by passing the layer over a first and a second roller, wherein the first roller is provided with a negative groove structure and the second roller is provided with a negative prism structure, so that a first surface of the layer is embossed with a groove structure and a second opposite surface of the layer is embossed with a prism structure. In this way, an anisotropic layer having two functions is provided in a relatively simple way. Thus, avoiding the necessity of providing an additional layer, which adds to the complexity, thickness and cost of manufacture of the illumination device.

### BRIEF DESCRIPTION OF THE DRAWINGS

In order that the invention may be more fully understood embodiments thereof with now be described by way of example only, with reference to the figures in which:

FIG. 1 shows a polarizing illumination device according to an embodiment of the present invention;

FIGS. 2a and 2b show further details of an anisotropic layer according to an embodiment of the present invention;

FIGS. 3a and 3b show light outcoupling distribution of a prior art device, and

FIGS. 4a and 4b show light outcoupling distribution of an illumination device according to an embodiment of the present invention.

### DESCRIPTION OF THE PREFERRED EMBODIMENTS

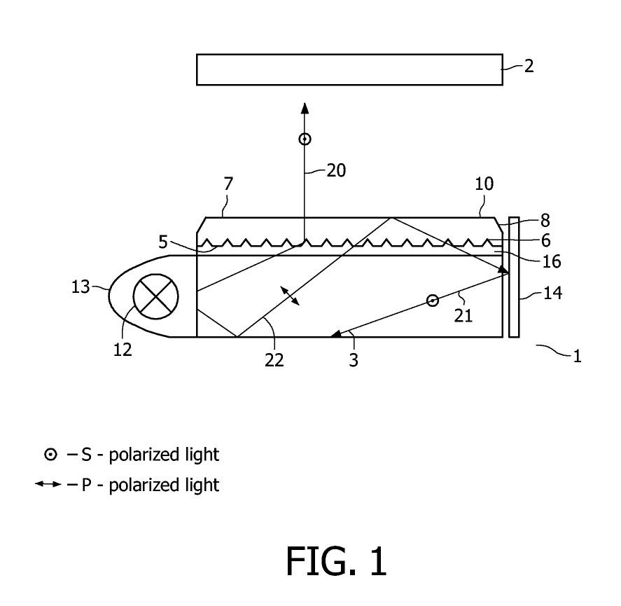

FIG. 1 shows a polarizing illumination device according to an embodiment of the present invention. In FIG. 1 an illumination device 1, for example a backlight, is shown for use with an LC display 2. The illumination device 1 comprises a waveguide 3 which is isotropic, a lamp 12 which is a source of S-polarized light 20 and P polarized light 22. The waveguide 3 may be of a material such as a plastic including PMMA, polycarbonate, or glass, or the like. A waveguide of PMMA for example, has a total internal reflection angle of 42 degrees and a refractive index n_{w} of 1.5.

The illumination device further comprises an anisotropic layer 10, also referred to as a foil, with a first surface 5 and a second surface 7. The first surface 5 and second surface 7 are provided with microstructures 6,8. The anisotropic layer 10 is adhered to the waveguide 1 with an index matching glue to form an isotropic adhesive layer 16. The microstructures 6 on the first surface 5 on the boundary between the isotropic adhesive layer 16 and the anisotropic layer 10 only deflects S polarized light 20. The S-polarized light 20 is the outcoupled light which is outcoupled from the waveguide 3 towards the LCD display 2. The P-polarized light is not outcoupled and remains inside the waveguide 3, where it may be transformed into S-polarized light 21 on its journey through the waveguide 3, for example on reflection from a depolarizing end reflector 14 which is disposed at one end of the waveguide 3. The S-polarized light 21 will then be eventually outcoupled by the anisotropic layer 10. In this way, the light from the lamp 12 is recycled.

With respect to the anisotropic layer 10, the layer may typically be in the form of a foil. The foil may be of a material such as polyethylene terephthalate (PET), polyethylene naphthalate, or the like. During production it may be stretched in one direction to render the foil uniaxial or slightly biaxial. For example, a stretched PET foil has an ordinary index of refraction n₀ of 1.52 in one direction in the plane of the foil and 1.56 in the perpendicular direction in the plane of the foil and an extraordinary index of refraction nₑ of 1.69. In one embodiment, the refractive index n₀ of the anisotropic layer 10 is substantially matched with the refractive index n_{w} of the waveguide.

The microstructures 6 on the first surface 5 are typically a plurality of grooves disposed in the first surface 5 along a first longitudinal axis 30. The groove structure couples out the S-polarized light because of a non-matching in the index of refraction between the adhesive layer 16 and the anisotropic layer 10, while there is an index matching between these two for the P-polarized light, which thus stays inside the waveguide 3. A main factor affecting the outcoupling efficiency of the S-polarized light is the absorption in the lamp 12 and reflector 13. The lamp reflector system 12, 13 does not couple all light in to the waveguide 3 and also an amount of light comes back after reflecting on the end reflector 14. A part of the light reflected by the reflector 14 is also absorbed. A typical absorption value of the lamp and reflector system when it is hit by light is around 40 percent. So, for example, by making the groove pitch smaller, less light goes back into the lamp and reflector system, thus, light efficiency is improved. Further factors influencing the outcoupling efficiency of the S-polarized light, the contrast ratio between the P and the S-polarized light and also the angular distribution of the S and P polarized light are the various indices of diffraction of the birefringent foil, the adhesive layer, the wave guide as well as the top angle of the grooves, the spacing between the grooves and the properties and efficiency of the deflector 14 at the end of the waveguide 3. According to the present invention, in order to improve the light distribution, in particular, in the direction parallel to the grooves, microstructures 8 are provided on the second surface 7. Thus, the anisotropic layer 10 has two functions: the layer 10 outcouples the S polarized light only and collimates the outcoupled light in a predetermined direction, for example in the groove direction.

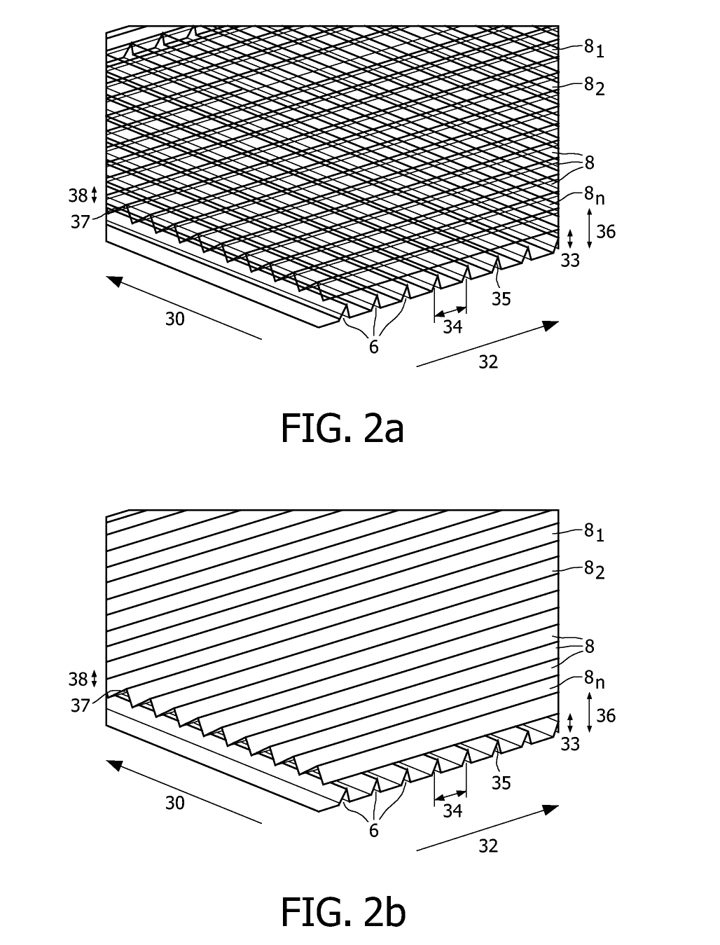

FIGS. 2a and 2b show further details of an anisotropic layer according to an embodiment of the present invention. FIG. 2a shows an outline of the first and second surface, whereas FIG. 2b shows a solid view of the first surface and the second surface. In particular, the collimating means 8 may comprise a second plurality of microstructures 8 formed in or on the second surface 7 to collimate the outcoupled light, preferably in the direction of the first longitudinal axis 30 wherein at least one of the second plurality of microstructures 8 has a second longitudinal axis 32. The first longitudinal axis 30 is disposed at an angle with respect to the second longitudinal axis 32. It has been found that preferably the angle between the first and second longitudinal axes lies within the range 90 degrees minus the total internal reflection angle of the waveguide to 90 degrees plus the total internal reflection angle. So, for example, for a waveguide 3 of PMMA or glass having a total angle of reflection of 42 degrees, as determined in accordance with Snell's law, the range extends from 90−42 to 90+42, i.e. 48 to 132 degrees. In the embodiment shown in FIG. 2, the first longitudinal axis 30 is substantially perpendicular to the second longitudinal axis 32, i.e. an angle of substantially 90 degrees. The second plurality of microstructures 8 comprises a plurality of optical elements 8₁, 8₂ . . . 8ₙ extending out of the second surface 6, the optical elements 8₁, 8₂, 8ₙ serving to increase the surface area of the second surface 6. In one embodiment, the optical elements extend out of the second surface, the optical elements are disposed at an angle with respect to a plane in which the waveguide is disposed. In a further embodiment, the angle is in a range of about plus or minus 45 degrees. In FIGS. 2a and b, the optical elements are prisms. However, it has been found that the microstructures 8 are not limited to prisms, for example, rectangular prisms as shown in FIGS. 2a and b. In fact, it has been found that any top layer structure, that is any structure formed in or at the surface of the anisotropic layer 10 facing towards the LCD display, having a relatively large surface area is suitable for collimating the light.

It has been found that the outcoupled light is collimated if the exit surface of the light is at an oblique angle with respect to a plane in which the waveguide is disposed. In particular, the optical elements may extend out of the second surface and may be disposed at an angle with respect to the plane in which the waveguide is disposed.

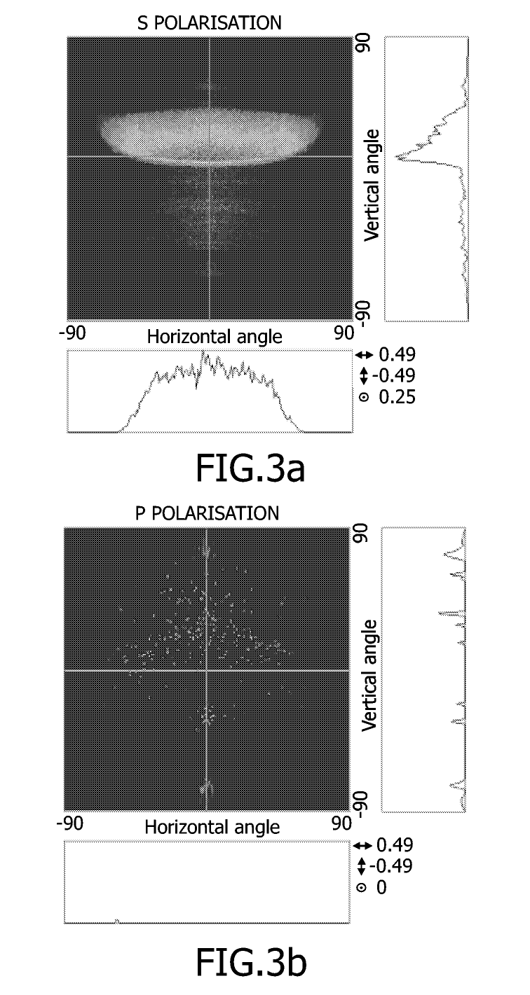

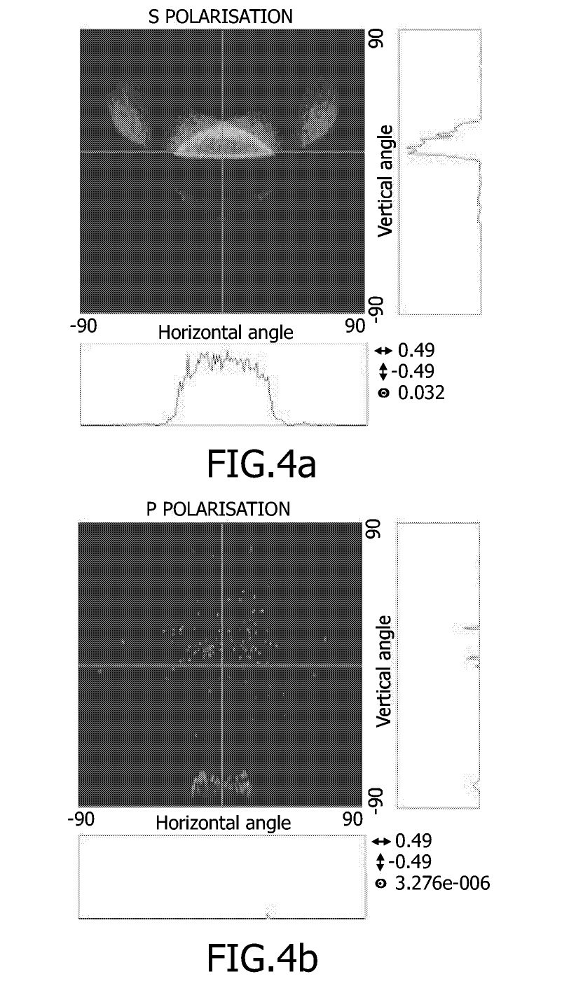

Further, by decreasing the pitch between microstructures 8₁, 8₂ etc, to provide a relatively large surface area, the degree of collimation is increased, since horizontal portions of the exit surface bearing no microstructures will not collimate the outcoupled light. The exit angle of the outcoupled light depends on the indices of refraction of the anisotropic layer. For a foil having the indices of refraction given above, microstructures 8 making an angle of in the range of about minus 45 to plus 45 degrees with the plane of the waveguide 3 provide good light collimation and hence light distribution results. In further embodiments, the optical elements 8 may have a wavelike structure, such as a sinusoidal function. In a further embodiment, the optical elements 8 may comprise a prism having different sizes. It has been found that if a mixture of prisms is provided whose sizes are relatively large and small with respect to one another, Moiré effects are minimized. Further, the prisms may be tilted with respect to one another. It has been found that the microstructures 8 required for a particular application depend on the properties of the anisotropic layer, for example, its indices of refraction and on the particular application envisaged for the anisotropic layer. For example, a plurality of microstructures 8 comprising prisms collimate the light in one direction. Depending on the orientation of the second longitudinal axis with respect to the first longitudinal axis, the prisms can be oriented to collimate the light in a range of directions. For example, when the first longitudinal axis is oriented substantially perpendicularly to the second longitudinal axis, the light is collimated in a horizontal direction, as shown and described with reference to FIGS. 3 and 4. Further, when the first axis is oriented at an intermediate angle with respect to the second axis, the direction of collimation is also intermediate to the vertical and horizontal directions.

FIGS. 3a and 3b show light outcoupling distribution of a prior art device, and FIGS. 4a and 4b show light outcoupling distribution of an illumination device according to an embodiment of the present invention. In particular, FIGS. 3a and 3b show the light outcoupling distribution of a prior art polarizing backlight as seen from the top of the polarizing backlight where the lamp position is at the bottom of the FIG. 3. In FIG. 3a, the S polarized light is shown, while in FIG. 3b, the P polarization is shown. It is seen that, in particular, the light distribution of the outcoupled S-polarization light is broad.

FIGS. 4a and 4b show the light outcoupling distribution of the polarizing backlight having a prism structure on the top as seen from the top of the polarizing backlight, i.e. on the second surface 6. The lamp position is shown at the bottom of FIGS. 4a and 4b. In FIG. 4a, the S polarized light is shown, while in FIG. 4b, the P polarization is shown. Simulations of the prior art backlight are shown in FIGS. 3a and 3b, while FIGS. 4a and 4b show simulation results of a backlight according to an embodiment of the invention having a prism structure on top. In these Figures, the horizontal angle is plotted on the x axis and the vertical angle is plotted on the y axis. In the graphs shown underneath and to the side of the main Figures, the underneath graph shows the intensity of outcoupled light on the y axis against the horizontal angle on the x axis. The graph to the side of the main figures shows the intensity of outcoupled light on the y axis against the vertical angle on the x axis. In these simulations the anisotropic layer has indices of refraction as given with reference to FIG. 2, the groove depth 33 is 50 micrometers, the groove pitch 34 is 200 micrometers, the groove top angle 35 is 65 degrees, the foil thickness 36 is 100 micrometers, the prism top angle 37 is 90 degrees and the prism height 38 is 50 micrometers. From a comparison of FIGS. 3 and 4, it is clearly seen that the S-polarized light is much more concentrated towards the normal viewing angle. This effect is due to the prism microstructures shown in FIG. 2. It is also clearly shown that there is no increase in the P polarized light outcoupled from the waveguide. Thus, the contrast does not suffer as a result of the presence of the microstructures, in particular, the prisms disposed on the top of the anisotropic layer 10. One method of making the foil of the present invention, is to emboss a foil with two rollers between which the heated foil is pressed. The first roller is provide with the negative groove structure while the second roller is provided with the negative prism structure. However, the method is not limited in this respect. In an alternative embodiment, the foil is chiseled on both sides in accordance with the chosen first and second microstructure forms. In a further embodiment, laser ablation may be used to profile the foil in the desired manner.

In the embodiments shown, S-polarized light is outcoupled. However, the invention is not limited in this respect, the outcoupled light may, in an alternative embodiment, be P-polarized light.

Whilst specific embodiments of the invention have been described above, it will be appreciated that the invention may be practiced otherwise than as described. The description is not intended to limit the invention.

1. An illumination device (1) for illuminating a display (2) with polarized light, comprising:
a waveguide (3) for guiding light, and
an anisotropic the layer (10) having a first surface (5) arranged to face towards the waveguide(3) and a second surface (7) arranged to face away from the waveguide (3), wherein the first surface (5) is provided with an outcoupling means (6) for outcoupling light (20) having a predetermined polarization from the waveguide (3) and the second surface (7) is provided with a collimating means (8) for collimating the light outcoupled from the waveguide in a predetermined direction.

2. A device according to claim 1, wherein the outcoupling means (6) comprises a first plurality of microstructures (6) formed in the first surface (5) wherein at least one of the first plurality of microstructures (6) has a first longitudinal axis (30), and wherein the collimating means (8) comprises a second plurality of microstructures (8) formed in the second surface (7).

3. A device according to claim 2, wherein the second plurality of microstructures (8) is arranged to collimate the light in the direction of the first longitudinal axis (30).

4. A device according to claim 3, wherein at least one of the second plurality of microstructures (8) has a second longitudinal axis (32) which is disposed at an angle with respect to the first longitudinal axis (30).

5. A device according to claim 4, wherein the angle between the first and second longitudinal axes (30, 32) is in a range defined from 90 degrees minus a total internal reflection angle of the waveguide (3) to 90 degrees plus the total internal reflection angle.

6. A device according to claim 4, wherein the first longitudinal axis (30) is substantially perpendicular to the second longitudinal axis (32).

7. A device according to claim 2, wherein the first plurality of microstructures (6) comprises a plurality of grooves.

8. A device according to claim 3, wherein the second plurality of microstructures (8) comprises a plurality of optical elements extending out of the second surface (6), the optical elements being disposed at an angle with respect to a plane in which the waveguide is disposed.

9. A device according to claim 8, wherein the angle is in a range of about plus or minus 45 degrees.

10. A device according to claim 8, wherein the optical elements (8) are prisms.

11. A device according to claim 10, wherein the prisms (8) are tilted with respect to one another.

12. A device according to claim 10, wherein the prisms (8) are of different sizes.

13. A device according to claim 8, wherein the optical elements (8) have a wavelike structure.

14. A device according to claim 13, wherein the wavelike structure has a sinusoidal function.

15. A device according to claim 8, wherein the optical elements (8) increase the surface area of the second surface.

16. A device according to claim 1, wherein a refractive index (no) of the anisotropic layer (10) is substantially matched with a refractive index of a material of the waveguide (3).

17. A liquid crystal display device, comprising a liquid crystal display panel and an illumination device (1) according to claim 1, for providing polarized light to said liquid crystal display panel.

18. A method of manufacturing an illumination device (1) for illuminating a display (2) with polarized light, the method including:
providing an anisotropic layer (10);
embossing the anisotropic layer (10) by passing the layer over a first and a second roller, wherein the first roller is provided with a negative groove structure and the second roller is provided with a negative prism structure, so that a first surface of the layer is embossed with a groove structure (6) and a second opposite surface of the layer is embossed with a prism structure (8),
joining the anisotropic layer (10) with a waveguide (3), so that the first surface of the layer faces towards the waveguide and the second surface of the layer faces away from the waveguide.
